(19) United States
(12) Patent Application Publication
(10) Pub. No.: US 2018/0236920 A1
(43) Pub. Date: Aug. 23, 2018

(54) HOLDING DEVICE FOR A VEHICLE

(71) Applicant: Gentherm GmbH, Odelzhausen (DE)

(72) Inventors: Sven Watzke, Augsburg (DE); Alexander Rappl, Königsbrunn (DE)

(21) Appl. No.: 15/735,756

(22) PCT Filed: Nov. 11, 2016
(86) PCT No.: PCT/DE2016/000394

§ 371 Date: Dec. 12, 2017

(30) Foreign Application Priority Data
Nov. 11, 2015 (DE) 10 2015 014 464.2

(51) Int. Cl. B60N 3/10; F25B 21/02

(52) U.S. Cl. CPC B60N 3/104; B60H 1/32; F25B 21/02

(57) ABSTRACT

The present teachings relate to a holding device for a vehicle, having at least one temperature control device that includes at least one thermoelectric device. The at least one thermoelectric device has a use side and a compensation side, and the temperature control device includes at least one regulation device that at least temporarily applies a working voltage to the at least one thermoelectric device, and the working voltage is a direct voltage.

The invention relates to a holding device for a vehicle, having at least one temperature control device that includes at least one thermoelectric device, the at least one thermoelectric device having a use side and a compensation side. The invention further relates to a holding system having at least two holding devices, and to a vehicle.

Moreover, the invention relates to a method for operating a holding device for a vehicle, having the step of providing a temperature control device that includes at least one thermoelectric device, the at least one thermoelectric device having a use side and a compensation side. Furthermore, the invention relates to a method for operating a holding system having at least two holding devices.

Known holding devices are used, for example, as temperature-controllable beverage holders in motor vehicles. Embodiments are known in which containers such as cans, bottles, or the like may be fixed in the beverage holder. For controlling the temperature of the beverages, generic holding devices generally have a temperature control device that includes at least one thermoelectric device.

Thermoelectric devices usually include a use side and a compensation side. The use side is the side of a thermoelectric device which in an operating state under consideration is provided for exchanging heat energy with a target zone to provide heat or cold for the target zone, or to absorb its heat energy in order to generate electrical energy. The target zone is, for example, a flat or three-dimensional area that is to be temperature-controlled, for example an inner area of a holding device and/or products or objects held therein. The compensation side is the side of a thermoelectric device which in an operating state under consideration is provided for exchanging heat energy with the surroundings in order to discharge waste heat of the thermoelectric device into the surroundings, or to supply the thermoelectric device with heat from the surroundings.

However, known holding devices have a high energy demand. Reducing the energy demand is desirable, in particular with regard to vehicles having an electric drive and a limited battery capacity. In addition, an improvement in the temperature control is also sought in order to allow target zones to be heated even to fairly high temperatures or to be cooled to low temperatures.

The object of the invention, therefore, is to provide an option that allows operation of a holding device with low energy consumption and improved temperature control. A further aim is for the holding device to have an uncomplicated design and for operation to be easily implemented.

The object underlying the invention is achieved by a holding device of the type mentioned at the outset, the temperature control device having at least one regulation device that at least temporarily applies a working voltage to the at least one thermoelectric device, the working voltage being a direct voltage.

The invention makes use of the finding that a regulation device may be used to adapt the working voltage that is applied to the at least one thermoelectric device, depending on the situation or need. In this way, the energy consumption of the holding device may be reduced, and temperature control may take place as needed.

The holding device according to the invention may be a device for accommodating foods or commodity goods. For this purpose, the holding device preferably has at least one holder into which an object to be temperature-controlled is insertable. The at least one thermoelectric device is preferably positioned in the area of the at least one holder, so that an object inserted into the at least one holder may be acted on by heat and/or cold energy by means of the at least one thermoelectric device. The regulation device is a device for regulating at least one parameter of the holding device. The regulation device may also be configured for regulating multiple parameters and/or multiple different or identical units of the holding device. The holding device is designed in particular for operation in vehicles. The holding device may be integrated into the vehicle or fixedly installed in a vehicle. Within the meaning of the invention, a vehicle is understood to mean a means for transporting persons or goods. In particular road and rail vehicles, motor vehicles, ships, and aircraft are encompassed. A temperature control device is a device for controlling the temperature of at least one target zone, wherein the temperature control may include changing the temperature of the target zone relative to its starting state, bringing and/or holding the temperature of the target zone to/at a setpoint temperature, and/or controlling the temperature of the target zone by a setpoint difference that differs from an ambient temperature. The thermoelectric device may include at least one Peltier element and/or one Seebeck element or may be designed as such. A Peltier element is a flat semiconductor element which, upon application of a voltage, heats up on one side and cools down on an opposite side. A Seebeck element is a flat semiconductor element that generates a voltage when one of its sides is heated and an opposite side is cooled. The working voltage of the thermoelectric device is a voltage that is applied at least in certain operating states. Its value serves to achieve a specific work purpose. Direct voltage is a voltage whose drop in potential does not reverse over a period of time under consideration, i.e., does not change from plus to minus, but instead is always greater than or equal to zero or always less than or equal to zero, in particular over the entire duration of a certain operating state. The regulation device may be designed as a computerized system.

In one preferred embodiment, the working voltage is unclocked. The unclocked working voltage is preferably not pulse width-modulated. In particular, the value of the working voltage at best changes continuously; in particular, the working voltage lies within a voltage range between 9 volts and 16 volts or within an interval of −30% to +30% around the magnitude of the supply voltage, wherein the supply voltage is a voltage that is provided directly by a voltage source. The supply voltage may be a battery voltage of 12 volts, 24 volts, or 48 volts, for example, or a mains voltage of 220 volts or 380 volts, for example. A bell-shaped pattern of a ΔT-V curve is typical for thermoelectric devices or electrothermal converters. That is, an increasing working voltage initially increases the achievable temperature effect, but after an ideal voltage is exceeded the achievable temperature effect once again decreases. This is because the internal resistance effects, which result in heat generation within the thermoelectric device and counteract the heat pump effect, then predominate. However, such a curve results only with unclocked direct voltage. For clocked voltage, the ΔT-V curve has a linear rise, and extends far below the bell curve. The temperature control performance that is achievable is thus often far below that for unclocked direct voltage. This effect is stronger the higher the operating point is above the optimal voltage value, sometimes up to 90%.

Alternatively, the working voltage may be clocked. The value of the clocked operating voltage preferably changes repeatedly, in particular between at least two values. The change in the working voltage value takes place in particular at regular intervals for a fixed duration, with zero as one of at least two values, with the maximum supply voltage as one of at least two values, with the maximum operating voltage as one of at least two values, with the maximum working voltage as one of at least two values, and/or with a sawtooth-like, sinusoidal, or square-wave voltage-time curve. The operating voltage is a voltage that is used for the internal operation of a temperature control device. The operating voltage may correspond to the supply voltage and/or may be 12 volts, 24 volts, or 48 volts, for example from cells of an electrochemical store. However, the operating voltage may also be different from the supply voltage, for example as the result of transformation of mains high voltage. The clocked working voltage is preferably pulse width-modulated. The pulse width modulation is a type of modulation in which a technical variable, for example the voltage, changes between two values. The duty cycle of a square-wave pulse, i.e., the width of the pulses that form it, is varied at constant frequency. The working voltage may be equal to the supply voltage and/or the operating voltage.

In another embodiment, the holding device according to the invention has a voltage converter which is at a supply voltage during operation. The voltage converter converts an applied input voltage into an output voltage that is output by the voltage converter. The input voltage is preferably a supply voltage or an operating voltage. The output voltage is preferably an operating voltage or a working voltage. The voltage converter preferably has at least one direct voltage converter or is formed from such. A direct voltage converter is a voltage converter in which at least the output voltage is a direct voltage. The direct voltage converter preferably outputs a working voltage. The input voltage is also preferably a direct voltage.

The working voltage is preferably different in two different operating states, as a function of a desired operating behavior of at least one thermoelectric device. The magnitude of the working voltage is preferably less than the supply voltage. The magnitude of the working voltage is preferably less than the operating voltage. However, the magnitude of the working voltage may also be greater than the supply voltage or the operating voltage when this is required by a component, for example a thermoelectric device designed for 24 volts, or by a circuit, in particular a series circuit, of multiple components, for example three thermoelectric devices in series, each designed for 6 volts.

In one refinement of the holding device according to the invention, the temperature control device is provided for operation at a supply voltage. Alternatively or additionally, the supply voltage is a direct voltage. Alternatively or additionally, the working voltage has a different magnitude than the supply voltage. In particular, the temperature control device is designed for operation with a supply voltage of a direct current source.

In one particularly preferred embodiment of the holding device according to the invention, the regulation device has at least one voltage converter, which during operation is at a supply voltage and/or at least temporarily delivers an output voltage. In another embodiment, the regulation device is formed as such a voltage converter. The voltage converter of the regulation device converts an applied input voltage into an output voltage that is output by the voltage converter. The input voltage is preferably a supply voltage or an operating voltage. The output voltage is preferably the working voltage of the at least one thermoelectric device. The voltage converter of the regulation device preferably has at least one direct voltage converter or is formed from such. A direct voltage converter is a voltage converter in which at least the output voltage is a direct voltage. The direct voltage converter preferably outputs a working voltage. The input voltage is also preferably a direct voltage.

The holding device according to the invention is also advantageously refined in that the output voltage of the voltage converter of the regulation device corresponds to the working voltage. Alternatively or additionally, the output voltage of the voltage converter of the regulation device is a direct voltage that is different from the supply voltage. The voltage converter of the regulation device is preferably configured for converting the operating voltage of an energy source to a voltage value that is above or below the operating voltage.

In another embodiment, the holding device according to the invention is designed as a glove compartment, beverage holder, or cool box, the holding device preferably being integrated into the vehicle, or installable in a vehicle or operable in a vehicle as a retrofittable accessory.

Furthermore, a holding device according to the invention is preferred in which the temperature control device has at least one fluid conveying device that is configured for discharging, by fluid movement, waste heat that arises on the compensation side of the thermoelectric device, and/or for supplying the compensation side of the thermoelectric device with heat by fluid movement. Heat conduction ribs and/or lamellae for increasing the heat exchange may be situated on the compensation side. In practice, it has been shown that temperature control via only thermoelectric devices is often not sufficient to ensure adequate heating or cooling of the target zone. The temperature control performance is further increased by the at least one fluid conveying device. The fluid flow rate per unit time of the at least one fluid conveying device is preferably different in two different operating states, depending on the desired operating behavior. The fluid conveying device may include one or more fans and/or pumps, in particular radial and axial fans. Within the meaning of the invention, a fluid is understood to mean a mass without a fixed shape, wherein the fluid may in particular be gaseous, vaporous, or granular, or liquid. Alternatively, the fluid may have a mixed form. The fluid may be water, air, or liquid coolant, for example. The fluid conveying device may include a pump system with a fluid circuit, the fluid circuit being in operative connection with the at least one thermoelectric device in order to apply heat to the compensation side of the at least one thermoelectric device or to discharge heat from the compensation side of the at least one thermoelectric device.

The holding device may be a cooling device. A cooling device is a device for cooling a target zone, for example by means of one or more thermoelectric devices. The holding device may also be a heating device. A heating device is a device for heating a target zone, for example by means of one or more heating resistors and/or thermoelectric devices. The holding device may also be operable as a cooling and heating device.

The fluid conveying device and/or the thermoelectric device may be operated at ideal voltage, for which the fluid conveying device and/or the thermoelectric device provide the maximum net power. For a fluid conveying device, the ideal voltage is preferably the maximum possible working voltage. A fan, for example, achieves its maximum speed and maximum delivery volume in this way. For a heating device, the ideal voltage is preferably likewise the maximum possible working voltage. A heating current reaches its maximum value in this way, so that the heating device delivers the maximum heating power that is possible in a given system configuration. For a thermoelectric device, the ideal voltage, at least in cooling mode, is usually different from the maximum possible working voltage. The ideal voltage is preferably below the maximum available working voltage, in particular below the operating voltage. However, it may also be above same when this is required by a component or a circuit of multiple components. For use of a thermoelectric device for heating, for example the maximum achievable voltage is optimal for optimal heating power. For use of the same thermoelectric device for cooling, it is advantageous to select some other voltage value in order to optimize the cooling power.

In another advantageous refinement of the holding device according to the invention, the regulation device is configured for autonomously setting the working voltage of the thermoelectric device and/or the fluid flow rate per unit time of the fluid conveying device. The regulation device is preferably coupled to the at least one thermoelectric device and to the at least one fluid conveying device in order to regulate the action of heat and/or cold energy on the target zone to be temperature-controlled, and the fluid flow rate per unit time of the at least one fluid conveying device.

In one preferred embodiment of the holding device according to the invention, the regulation device is configured for autonomously setting the working voltage as a function of the fluid flow rate per unit time of the fluid conveying device. Alternatively or additionally, the regulation device is configured for autonomously setting the fluid flow rate per unit time of the fluid conveying device as a function of the working voltage of the thermoelectric device. In particular, the regulation device has information that associates a setpoint voltage for the at least one thermoelectric device with a fluid flow rate per unit time. The information may be stored as an algorithm on the regulation device. The voltage for the at least one thermoelectric device is preferably automatically adapted by the regulation device as a function of the predefined fluid flow rate per unit time, taking the information into account. Alternatively or additionally, the fluid flow rate per unit time is automatically adapted by the regulation device as a function of the predefined voltage of the at least one thermoelectric device, taking the information into account.

In another embodiment of the holding device according to the invention, the temperature control device has a sound volume-optimized operating mode. For a sound volume-optimized operating mode, noise-producing components of the holding device, such as the fluid conveying device, are adapted to the surrounding conditions in the vehicle. The flow rate of the fluid in the fluid conveying device of the holding device influences the net power of the holding device. The net power is the heat energy flow that is withdrawn from the target zone in cooling mode, or that is provided to the target zone in heating mode. An increase in the flow rate of the fluid generally has a positive effect on the net power, but has a negative effect on the noise production. Conversely, a decrease in the flow rate of the fluid generally has a negative effect on the net power, but has a positive effect on the noise production. Deviations therefrom may occur, for example, in the resonance range of the fluid conveying device. When there are such deviations, it may be advantageous to increase the fluid flow under certain circumstances in order to leave the resonance range. In the standard sound volume mode, the fluid conveying device is operated at a specified fluid flow rate per unit time, which is defined based on the optimal ratio of the noise production to the net power of the holding device. In the sound volume-optimized mode, the fluid flow rate per unit time is dynamically adapted based on the surrounding conditions. As the result of detecting the surrounding conditions by means of sensors, for example one or more microphones, signals such as a tacho signal, or a signal relating to the use of a hands-free device or the use of mobile phone communication, the flow rate is appropriately reduced, and accordingly a reduction in the sound volume is achieved. A change in the fluid flow rate also changes the maximum possible net power. This requires an adaptation of the maximum electrical power. Reducing the fluid flow rate per unit time may result in exceeding the maximum electrical power, require a marked reduction in the net power, result in a reduction in the maximum electrical power, and/or require setting a new maximum net power, thereby minimizing the reduction in net power. Parameter sets for the ratios of the fluid delivery rate to the sound volume level of the fluid conveying device are preferably stored in the holding device. When a sound volume level is measured by an acoustic measuring device, the fluid conveying device may be adapted so that the fluid conveying device is quieter than the measured ambient noise. The ambient noise measurement may be averaged over a period of time so that interference noises, such as conversations or brief loud sounds, are not included in the regulation. To eliminate such sources of interference, the controller of the measuring device may ignore peaks that are significantly different, thus taking into account only the baseline sound volume level for regulating the fluid conveying device. Using the sound volume-optimized operating mode is particularly preferred during use of a hands-free device, at low vehicle speed, at a standstill or with the engine switched off with an automatic start-stop system, at a low radio volume or with the radio turned off, or when a low noise level is detected by measurement data of a noise measuring system. When a high noise level is detected, the sound volume-optimized operating mode may be discontinued, for example during operation of noise-producing components in the vehicle, such as a neck warmer, when the air conditioner blower is activated, when the window or roof is open, or when ground noise is detected, for example when traveling over cobblestones. The detection of the noise level may accordingly take place, for example, by detecting the operating state of the hands-free device, the driving speed, the state of the radio or audio system, the operating state of noise-producing components, the state of the engine, the radio volume, the state of the window or roof, or the state of the shock absorbers.

Alternatively or additionally, the temperature control device may have an energy-saving operating mode in which a thermal function at reduced power consumption is provided. In the energy-saving mode, the at least one temperature control device, the at least one thermoelectric device, and/or the at least one fluid conveying device are/is preferably operated in such a way that the electrical power consumed is reduced compared to at least one other operating mode, preferably compared to all operating modes with a similar task. This preferably takes place by reducing the working voltage. The desired target temperature or target temperature difference is preferably further maintained or sought in this mode. For this purpose, preferably at least one temperature control device is switched off or its temperature control performance is reduced, while the at least one fluid conveying device continues operation at an unreduced or reduced delivery rate.

Alternatively or additionally, the temperature control device may have an operating mode for producing ice. This ice mode is preferably a cooling mode in which the desired target temperature, at least locally, in an inner area of the holding device is zero or less than one degree Celsius. A sensor preferably provides the instantaneous temperature on the use side of the thermoelectric device, and/or a sensor detects the ambient temperature of intake air. The formation of ice may be controlled and monitored in this way.

Alternatively or additionally, the temperature control device may have an operating mode for avoiding ice formation. This anti-ice mode is preferably a heating or cooling mode in which formation of ice in the holding device is avoided, independently of a desired target temperature or target temperature difference. In at least one anti-ice mode, at least one temperature control device operated as a cooling device is preferably switched off, its cooling power is reduced, and/or a working voltage applied to it is reduced.

Alternatively or additionally, the temperature control device may have an operating mode for avoiding condensate formation. In particular, two operating modes may be set for avoiding condensate water on the compensation side of the at least one thermoelectric device. In a first operating mode, the temperature control device is in a heating mode in which the fluid conveying device is switched off in order to achieve noise reduction. In a second operating mode, the temperature control device is in a heating mode in which the fluid conveying device is operated at reduced power in order to avoid the condensate formation on the compensation side.

Alternatively or additionally, the temperature control device may have an operating mode in which the net power is optimized. In the net power-optimized mode, the fluid flow rate per unit time is dynamically adapted based on the surrounding conditions. As the result of detecting the surrounding conditions by means of sensors, for example one or more microphones, signals such as a tacho signal, or a signal relating to the use of a hands-free device or the use of mobile phone communication, the flow rate is appropriately decreased, and accordingly an increase in net power is achieved. Based on the flow rate adaptation, the maximum electrical power may be increased, and accordingly the maximum net power may be increased. Increasing the flow rate causes the point of maximum net power to shift in the direction of higher electrical power, resulting in an increase in the maximum electrical power. This requires setting of the new maximum net power.

In another embodiment of the holding device according to the invention, the temperature control device avoids the development of current spikes when at least one operating mode is activated. To avoid current spikes when the holding device is switched on, a voltage converter may be used which avoids current spikes at the moment of switching on. In this way the voltage is run up in a controlled manner, preferably in the form of a linear voltage rise.

The object underlying the invention is further achieved by a holding system of the type mentioned at the outset, the holding system preferably having a regulation device that divides the available energy between the at least two holding devices, depending on the operating mode selected. Due to the operating mode-dependent division of the available energy, a distribution of energy is implemented depending on the situation or need, resulting in a reduction in the energy demand, and at the same time, temperature control as needed. The holding system may also have a plurality of holding devices.

In one particularly preferred embodiment of the holding system according to the invention, the two holding devices are each operable in a heating mode and in a cooling mode. In the heating mode, the particular holding device is supplied with heat energy, in particular in order to achieve a preset or individually selected target temperature that is higher than the temperature of the surroundings, or to achieve a temperature difference between an inner area of the particular holding device and the surroundings, corresponding to a preset or individually selected value. In the cooling mode, heat energy is withdrawn from the particular holding device in order to achieve a preset or individually selected target temperature that is lower than the temperature of the surroundings, or to achieve a temperature difference between an inner area of the particular holding device and the surroundings, corresponding to a preset or individually selected value.

The holding system is further advantageously refined in that, by means of the regulation device, at least one operating mode is settable in which one holding device is operated in the heating mode and one holding device is operated in the cooling mode. When the available electrical power is greater than or equal to the sum of the maximum electrical power of the holding device operated in the heating mode and of the holding device operated in the cooling mode, the holding device operated in the heating mode may be operated in a high-performance setpoint value lead-in mode until the setpoint value is reached, and after reaching the setpoint value a change is made to a setpoint value hold mode. At the same time, the holding device operated in the cooling mode may be operated in a high-performance setpoint value lead-in mode until the setpoint value is reached, and after reaching the setpoint value a change is made to a setpoint value hold mode. The setpoint value lead-in mode is an operating mode in which at least one temperature control device, at least one thermoelectric device, and/or at least one fluid conveying device provide(s) a net power at which a desired temperature setpoint value and/or a desired temperature difference with respect to the surroundings are/is advantageously achieved. For this purpose, preferably at least one component operates in a high-performance mode. The high-performance mode is an operating mode in which at least one temperature control device, at least one thermoelectric device, and/or at least one fluid conveying device provide(s) its maximum net power. For this purpose, preferably at least one component operating in the high-performance mode is connected to a voltage that brings about the maximum net power of the component. The setpoint value hold mode is an operating mode in which at least one temperature control device, at least one thermoelectric device, and/or at least one fluid conveying device provide(s) a net power at which a desired temperature setpoint value and/or a desired temperature difference with respect to the surroundings are/is maintained. For this purpose, preferably at least one component is connected to a working voltage that is reduced compared to its ideal voltage. When the available electrical power is less than the sum of the maximum electrical power of the holding device operated in the heating mode and of the holding device operated in the cooling mode, preferably a selection may be made between multiple operating modes, and/or a prioritization may take place. When priority is given to the holding device operated in the heating mode, the holding device operated in the heating mode may be operated in the setpoint value lead-in mode, preferably in the high-performance setpoint value lead-in mode, until the setpoint value is reached, and after reaching the setpoint value a change is made to the setpoint value hold mode. Unneeded power of the holding device operated in the cooling mode is thus made available. Thus, in the setpoint value lead-in mode, preferably in the high-performance setpoint value lead-in mode, the holding device operated in the cooling mode may consume the unneeded power of the holding device operated in the heating mode until the setpoint value is reached, and after reaching the setpoint value a change is made to the setpoint value hold mode. When priority is given to the holding device operated in the cooling mode, the holding device operated in the cooling mode may be operated in the setpoint value lead-in mode, preferably in the high-performance setpoint value lead-in mode, until the setpoint value is reached, and after reaching the setpoint value a change is made to the setpoint value hold mode. Unneeded power of the holding device operated in the heating mode is thus made available. Thus, in the setpoint value lead-in mode, preferably in the high-performance setpoint value lead-in mode, the holding device operated in the heating mode may consume the unneeded power of the holding device operated in the cooling mode until the setpoint value is reached, and after reaching the setpoint value a change is made to the setpoint value hold mode. When priority is given to the holding device operated in the heating mode, and the holding device operated in the cooling mode is to provide a minimum power, the holding device operated in the heating mode may be operated in the setpoint value lead-in mode, preferably in the high-performance setpoint value lead-in mode, until the setpoint value is reached, wherein a minimum power must be available for the holding device operated in the cooling mode. When the setpoint value is reached, a change is made to the setpoint value hold mode. Unneeded power of the holding device operated in the cooling mode is thus made available to the holding device operated in the heating mode. At the same time, in the setpoint value lead-in mode the holding device operated in the cooling mode may consume the unused power of the holding device operated in the heating mode until the setpoint value is reached, wherein at least the minimum power for the holding device operated in the cooling mode is available. When the setpoint value is reached, a change is made to the setpoint value hold mode. The minimum power is an electrical power for achieving a defined minimum net power. When priority is given to the holding device operated in the cooling mode, and the holding device operated in the heating mode is to provide a minimum power, the holding device operated in the cooling mode may be operated in the setpoint value lead-in mode, preferably in the high-performance setpoint value lead-in mode, until the setpoint value is reached, wherein a minimum power for the holding device operated in the heating mode must be available. When the setpoint value is reached, a change is made to the setpoint value hold mode. Unneeded power of the holding device operated in the heating mode is thus made available to the holding device operated in the cooling mode. At the same time, in the setpoint value lead-in mode the holding device operated in the heating mode may consume the unused power of the holding device operated in the cooling mode until the setpoint value is reached, wherein at least the minimum power for the holding device operated in the heating mode is available. When the setpoint value is reached, a change is made to the setpoint value hold mode. If no priority is given, the holding device operated in the heating mode and the holding device operated in the cooling mode may be operated in the setpoint value lead-in mode with equal division of the available power. After the setpoint value is reached, a change is made to the setpoint value hold mode. Unneeded power of the respective other holding device is thus made available.

Alternatively or additionally, by means of the regulation device at least one operating mode is settable in which one holding device is deactivated and one holding device is operated in the cooling mode. When the available electrical power is greater than or equal to the maximum electrical power of the holding device operated in the cooling mode, the holding device operated in the cooling mode may be operated in a high-performance setpoint value lead-in mode until the setpoint value is reached, and after reaching the setpoint value a change is made to a setpoint value hold mode. When the available electrical power is less than the maximum electrical power of the holding device operated in the cooling mode, the holding device operated in the cooling mode may be operated in the setpoint value lead-in mode, with consumption of the available electrical power, until the setpoint value is reached, and after reaching the setpoint value a change is made to a setpoint value hold mode.

Alternatively or additionally, by means of the regulation device at least one operating mode is settable in which one holding device is deactivated and one holding device is operated in the heating mode. When the available electrical power is greater than or equal to the maximum electrical power of the holding device operated in the heating mode, the holding device operated in the heating mode may be operated in a high-performance setpoint value lead-in mode until the setpoint value is reached, and after reaching the setpoint value a change is made to a setpoint value hold mode. When the available electrical power is less than the maximum electrical power of the holding device operated in the heating mode, the holding device operated in the heating mode may be operated in the setpoint value lead-in mode, with consumption of the available electrical power, until the setpoint value is reached, and after reaching the setpoint value a change is made to a setpoint value hold mode.

Alternatively or additionally, by means of the regulation device at least one operating mode is settable in which the two holding devices are each operated in the heating mode. When the available electrical power is greater than or equal to the sum of the maximum electrical power of the holding devices operated in the heating mode, the holding devices operated in the heating mode may each be operated in the high-performance setpoint value lead-in mode until the setpoint value is reached, and after reaching the setpoint value a change is made to a setpoint value hold mode. When the available electrical power is less than the sum of the maximum electrical power of the holding devices operated in the heating mode, various different operating modes may be set. When priority is given to the first holding device operated in the heating mode, the first holding devices operated in the heating mode may each be operated in the high-performance setpoint value lead-in mode until the setpoint value is reached, and after reaching the setpoint value a change is made to a setpoint value hold mode. In the setpoint value lead-in mode, the second holding device operated in the heating mode may thus consume the unneeded power of the first holding device operated in the heating mode until the setpoint value is reached, and after reaching the setpoint value a change is made to the setpoint value hold mode. If no priority is given, the first holding device operated in the heating mode and the second holding device operated in the heating mode may be operated in the setpoint value lead-in mode with equal division of the available power. After the setpoint value is reached, a change is made to the setpoint value hold mode. Unneeded power of the respective other holding device is thus made available.

Alternatively or additionally, by means of the regulation device at least one operating mode is settable in which the two holding devices are each operated in the cooling mode. When the available electrical power is greater than or equal to the sum of the maximum electrical power of the holding devices operated in the cooling mode, the holding devices operated in the cooling mode may each be operated in the high-performance setpoint value lead-in mode until the setpoint value is reached, and after reaching the setpoint value a change is made to a setpoint value hold mode. When the available electrical power is less than the sum of the maximum electrical power of the holding devices operated in the cooling mode, various different operating modes may be set. When priority is given to the first holding device operated in the cooling mode, the first holding device operated in the cooling mode may be operated in the high-performance setpoint value lead-in mode until the setpoint value is reached, and after reaching the setpoint value a change is made to a setpoint value hold mode. In the setpoint value lead-in mode, the second holding device operated in the cooling mode may thus consume the unneeded power of the first holding device operated in the cooling mode until the setpoint value is reached, and after reaching the setpoint value a change is made to the setpoint value hold mode. When no priority is given, the first holding device operated in the cooling mode and the second holding device operated in the cooling mode may be operated in the setpoint value lead-in mode with equal division of the available power. After the setpoint value is reached, a change is made to the setpoint value hold mode. Unneeded power of the respective other holding device is thus made available.

According to the above discussion, the individual holding devices may thus be operated, for example, in a high-performance heating mode, a setpoint value lead-in heating mode, a setpoint value hold heating mode, a high-performance cooling mode, a setpoint value lead-in cooling mode, and/or a setpoint value hold cooling mode. The high-performance heating mode is an operating mode in which at least one temperature control device, at least one thermoelectric device, and/or at least one fluid conveying device in high-performance mode operate(s) in the heating mode. The setpoint value lead-in heating mode is an operating mode in which at least one temperature control device, at least one thermoelectric device, and/or at least one fluid conveying device in setpoint value lead-in mode operate(s) in the heating mode. The setpoint value hold heating mode is an operating mode in which at least one temperature control device, at least one thermoelectric device, and/or at least one fluid conveying device in setpoint value hold mode operate(s) in the heating mode. The energy-saving heating mode is an operating mode in which at least one temperature control device, at least one thermoelectric device, and/or at least one fluid conveying device in energy-saving mode operate(s) in the heating mode. The high-performance cooling mode is an operating mode in which at least one temperature control device, at least one thermoelectric device, and/or at least one fluid conveying device in high-performance mode operate(s) in the cooling mode. The setpoint value lead-in cooling mode is an operating mode in which at least one temperature control device, at least one thermoelectric device, and/or at least one fluid conveying device in setpoint value lead-in mode operate(s) in the cooling mode. The setpoint value hold cooling mode is an operating mode in which at least one temperature control device, at least one thermoelectric device, and/or at least one fluid conveying device in setpoint value hold mode operate(s) in the cooling mode. The maximum electrical power of a temperature control device, a thermoelectric device, or a fluid conveying device is the electrical power that is received or consumed by a temperature control device, a thermoelectric device, or a fluid conveying device in high-performance mode.

The electrical power necessary for obtaining maximum net power in the heating mode may be greater than the electrical power necessary for maximum net power of the cooling mode. The voltage converter may be cost-effectively designed by designing it only for the maximum electrical power of the cooling mode. To supply the maximum electrical power for the heating mode of the holding device, a bypass of the voltage converter, for example via MOSFET, is incorporated. For this purpose, the operating voltage is applied directly to the temperature control device of the holding device.

The magnitude of the applied voltage may be selected according to the operating mode. For the maximum cooling power, an operating voltage may be selected for which the cooling power is maximum. This may correspond to the maximum of a bell curve. For setting a setpoint temperature difference, the voltage value may be selected for which the system achieves the desired temperature difference.

The respective holding devices may have one voltage converter for each temperature control device. Alternatively, each holding device may have exactly one voltage converter.

The object underlying the invention is further achieved by a method for operating a holding device of the type mentioned at the outset, wherein the method according to the invention includes at least temporarily applying a working voltage to the at least one thermoelectric device, the working voltage being a direct voltage. With regard to the advantages and modifications of the method according to the invention for operating a holding device, reference is made to the advantages and modifications of the holding device according to the invention.

The method may be used for controlling the temperature of objects such as beverage containers or the like, in which the object may be inserted into at least one holder, and the object inserted into the at least one holder may be acted on by heat or cold energy by means of at least one thermoelectric device, wherein the adapted voltage may be provided to the thermoelectric device as unclocked direct voltage. In other respects, the embodiments and modification options described above with regard to the holding device apply.

The method according to the invention is further advantageously refined by converting the supply voltage using at least one voltage converter, and/or setting the working voltage that is at least temporarily applied to the thermoelectric device. In other respects, the embodiments and modification options described above with regard to the holding device apply.

In one refinement of the method according to the invention, waste heat that arises on the compensation side of the thermoelectric device is discharged by means of a fluid conveying device, and/or heat is supplied to the compensation side of the thermoelectric device by means of a fluid conveying device. Heat is preferably supplied to the compensation side of the at least one thermoelectric device by means of the fluid conveying device, or heat is preferably discharged from the compensation side of the thermoelectric device by means of the fluid conveying device. In other respects, the embodiments and modification options described above with regard to the holding device apply.

In one particularly preferred embodiment of the method according to the invention, the working voltage is autonomously set in particular as a function of the fluid flow rate per unit time of the fluid conveying device. Alternatively or additionally, the fluid flow rate per unit time of the fluid conveying device is autonomously set, in particular as a function of the working voltage. Different setpoint voltages for the at least one thermoelectric device are preferably associated with the fluid flow rates per unit time of the fluid conveying device. Alternatively or additionally, the fluid flow rate per unit time may be increased or decreased, and a voltage for the at least one thermoelectric device may be thus be automatically adapted according to this association. Alternatively, the actual voltage for the at least one thermoelectric device may be increased or decreased, and the fluid flow rate per unit time of the fluid conveying device may be thus be automatically adapted according to this association. In other respects, the embodiments and modification options described above with regard to the holding device apply.

In another embodiment of the method according to the invention, a noise level is detected by sensor and/or the fluid flow rate per unit time of the fluid conveying device is autonomously set as a function of the detected noise level. The noise level is preferably detected and/or determined by sensor, and as a function of the detection and/or determination the fluid flow rate per unit time of the fluid conveying device is selectively increased or decreased, and a voltage for the at least one thermoelectric device is thus automatically adapted according to the association. The noise level is preferably detected and/or determined over a defined time interval, the noise level for the defined time interval is evaluated, and the fluid flow rate per unit time of the fluid conveying device is selectively increased or decreased, taking the evaluation into account. In other respects, the embodiments and modification options described above with regard to the holding device apply.

In addition, a method is preferred which includes setting a sound volume-optimized operating mode for the temperature control device, setting an energy-saving operating mode in which a thermal function at reduced power consumption is provided for the temperature control device, setting an operating mode for producing ice for the temperature control device, setting an operating mode for avoiding ice formation for the temperature control device, and/or setting an operating mode for avoiding condensate formation for the temperature control device. The embodiments and modification options described above with regard to the holding device apply with respect to the indicated operating modes.

In particular, the method according to the invention includes avoiding the development of current spikes when at least one operating mode is switched on, and/or operating the holding device as a cooling device and/or operating the holding device as a heating device. In other respects, the embodiments and modification options described above with regard to the holding device apply.

The object underlying the invention is further achieved by a method for operating a holding system of the type mentioned at the outset, wherein the available energy is divided between the at least two holding devices, depending on the operating mode selected. With regard to the advantages and modifications of the method according to the invention, reference is made to the advantages and modifications of the holding system according to the invention.

In one particularly preferred embodiment of the method according to the invention, the two holding devices are each operable in a heating mode and in a cooling mode. In other respects, the embodiments and modification options described above with regard to the holding system apply.

The method according to the invention is also advantageously refined by setting an operating mode in which one holding device is operated in the heating mode and one holding device is operated in the cooling mode, setting an operating mode in which one holding device is deactivated and one holding device is operated in the cooling mode, setting an operating mode in which one holding device is deactivated and one holding device is operated in the heating mode, setting an operating mode in which the two holding devices are each operated in the heating mode, and/or setting an operating mode in which the two holding devices are each operated in the cooling mode. In other respects, the embodiments and modification options described above with regard to the holding system apply.

The object underlying the invention is further achieved by a motor vehicle, the motor vehicle according to the invention having one or more holding devices according to one of the embodiments described above, and preferably being operated with a method for operating a holding device according to one of the embodiments described above, or the motor vehicle according to the invention having a holding system according to one of the embodiments described above and preferably being operated with a method for operating a holding system according to one of the embodiments described above.

For example, the motor vehicle includes a holding device designed as a glove compartment, cool box, or beverage holder of the motor vehicle. The regulation device and/or the control device may have an intelligent distribution logic system by means of which an operating voltage of the motor vehicle may be distributed over multiple temperature control devices, multiple thermoelectric devices, and/or multiple fluid conveying devices.

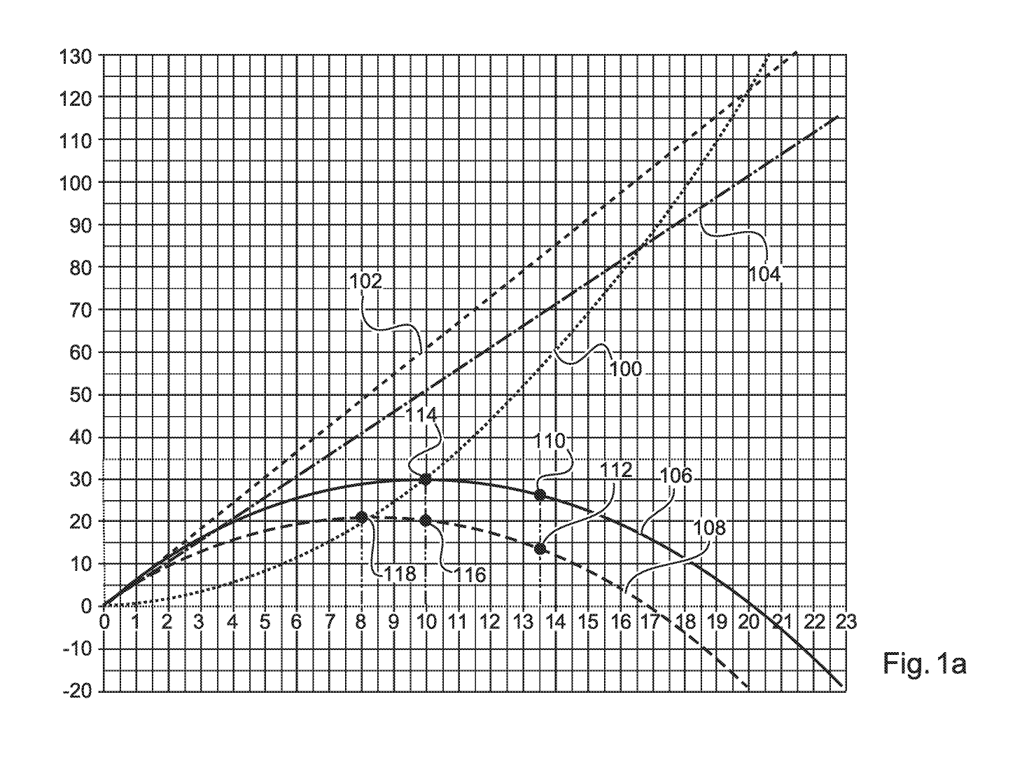

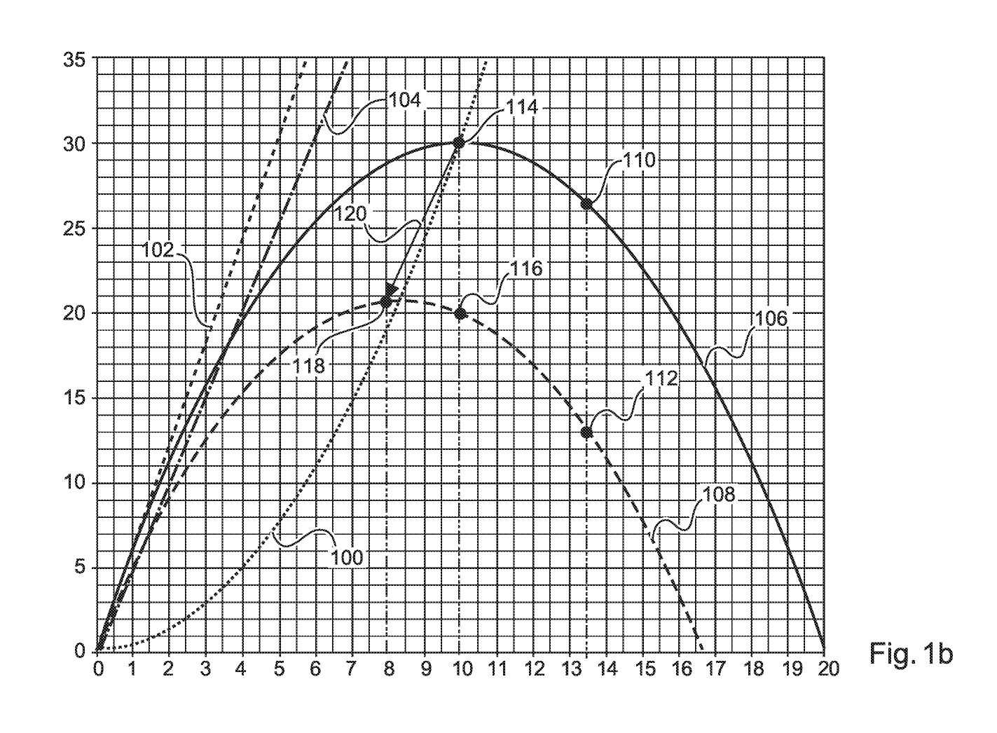

In one exemplary embodiment, the holding device is configured for controlling the temperature of a beverage container. The beverage container may be designed as a bottle or a beverage can, for example. The beverage container may be selectively heated or cooled by the holding device. To hold the beverage container during its temperature control, a holder is provided into which the beverage container is inserted. The beverage container is fixed in the holder via retaining elements. In addition, a thermoelectric device designed as a Peltier element is provided, and is positioned in the area of the holder in such a way that the beverage container inserted into the holder may be temperature-controlled via the Peltier element. The Peltier element is controlled by a regulation device. The regulation device may thus selectively provide for the beverage container to be acted on by heat energy or by cold energy. For acting on the beverage container by heat energy or cold energy, the Peltier element is supplied with unclocked direct current. The holding device also includes a fluid conveying device to further improve the effect of the cooling or heating brought about by the Peltier element. The fluid conveying device may be designed as a pump system and may have a fluid circuit in which a fluid is circulated. The fluid may be composed, at least in part, of water or some other liquid substance such as oil or salt solution. The high heat capacity of such materials promotes the heat exchange efficiency. A pump provides for circulation of the fluid. This pump is connected to the regulation device, which specifies a particular actual power of the pump. Thus, via the regulation device a certain quantity of fluid may be specified which is to be circulated per unit time in the fluid circuit. The pump system is in operative connection with the Peltier element, i.e., taps heat or cold from a compensation side of the Peltier element in order to increase the power of the Peltier element and thus act on the beverage container with higher heat energy or cold energy. For this purpose, a first heat transfer device is provided, which is situated below the Peltier element and is designed as an integral part of the fluid circuit or is in flow connection with the fluid circuit. The pump may be enclosed by a noise-damping capsule in order to reduce the noise level resulting from the device. To allow the largest possible amount of heat or cold to be tapped from the compensation side of the Peltier element and to counteract excessive, unintentional heating of the fluid, an intermediate store is provided as an integral part of the fluid circuit. As the fluid circulates, it passes through the intermediate store. The holding device also includes a second heat transfer device which is in heat exchange with the intermediate store and can discharge the heat or cold that is absorbed by the fluid from the compensation side of the Peltier element. This also counteracts excessive, unintentional heating or cooling of the fluid. Heat or cold of the fluid that is absorbed from the compensation side of the Peltier element is discharged via the second heat transfer device to the ambient air surrounding the device. The second heat transfer device may include a plurality of heat conduction ribs. In particular, heat conduction ribs may be attached to the intermediate store. In order for the Peltier element to act on the object with heat energy or cold energy with the greatest possible efficiency, the regulation device has information that associates a particular setpoint voltage for the Peltier element with a particular quantity of fluid to be moved per unit time. In practice, for example the holding device may be installed in a motor vehicle or designed as an integral part of a motor vehicle. Since an increase in the quantity of fluid to be moved per unit time is accompanied by greater noise production for the holding device, the quantity of fluid to be conveyed per unit time is adapted to a noise level that already exists in the interior of the motor vehicle. In particular, the adaptation may be such that the noise production by the device does not exceed the noise level that already exists in the interior of the motor vehicle. Such embodiments have proven to be advantageous in keeping passengers of a motor vehicle from being disturbed by noise produced by the holding device. The holding device therefore includes a sensor, connected to the regulation device, by means of which noise may be detected. If the noise level detected via the sensor increases, the regulation device may control the pump so that the quantity of fluid to be moved per unit time is increased. If the noise level detected via the sensor decreases, the regulation device may control the pump so that the quantity of fluid to be moved per unit time is decreased. In addition, the regulation device may be connected to a vehicle electronics system, and may adapt the quantity of fluid to be moved to, for example, a vehicle speed or the actual power of an air conditioning unit provided for the vehicle interior, or may selectively increase or decrease same. If the quantity of fluid to be moved per unit time is reduced, it has been shown in practice that the power of the Peltier element is designed to be greater when the voltage for the Peltier element is reduced and is not maintained. This relationship is depicted by way of example in FIGS. 1a and 1b. In order to keep the power for the Peltier element as great as possible, it is provided that the regulation device has information that associates a particular quantity of a fluid to be moved per unit time with a setpoint voltage, or conversely, associates a particular voltage for the Peltier element with a particular setpoint quantity of fluid to be moved per unit time. If the quantity of fluid to be moved per unit time is accordingly increased or decreased by the regulation device, the voltage for the Peltier element may be adapted according to the information stored on the regulation device. As the result of adapting the voltage, the beverage container may be temperature-controlled for each quantity of fluid to be moved per unit time in the most efficient manner possible. It may also be provided that initially a voltage of the Peltier element is increased or decreased, and the quantity of fluid to be moved per unit time is hereby adapted according to the information stored on the regulation device. For example, multiple holders may be provided, with which a dedicated Peltier element is associated in each case. The regulation device may then divide an operating voltage of a motor vehicle over the Peltier elements of the multiple holders, with the assistance of an intelligent distribution logic system. A Peltier element may thus be acted on by a voltage at which the Peltier element does not achieve its maximum power. In order to still apply heat energy or cold energy to the beverage container with the greatest possible efficiency, the quantity of fluid to be moved per unit time is adapted by the regulation device, taking into account the information stored on the regulation device. It is also conceivable for a beverage container to maintain its temperature by applying heat energy or cold energy to it. The information stored on the regulation device allows an association of the voltage with the quantity of fluid to be moved per unit time, in which the holding device may act on the beverage container with the appropriate heat energy or cold energy, with very low energy consumption. The regulation device is also connected to a user interface. Instructions for temperature-controlling the beverage container may be relayed to the regulation device via the user interface. For example, instructions may be given to the regulation device, via the user interface, to apply heat energy or cold energy to the beverage container. It is also conceivable for the quantity of fluid to be moved per unit time to be specified manually or via the user interface.

Preferred embodiments of the invention are explained and described in greater detail below with reference to the appended drawings, which show the following:

FIG. 1a shows various operating states of a thermoelectric device and of a fluid conveying device of a holding device according to the invention;

FIG. 1b shows a section from FIG. 1a in an enlarged illustration;

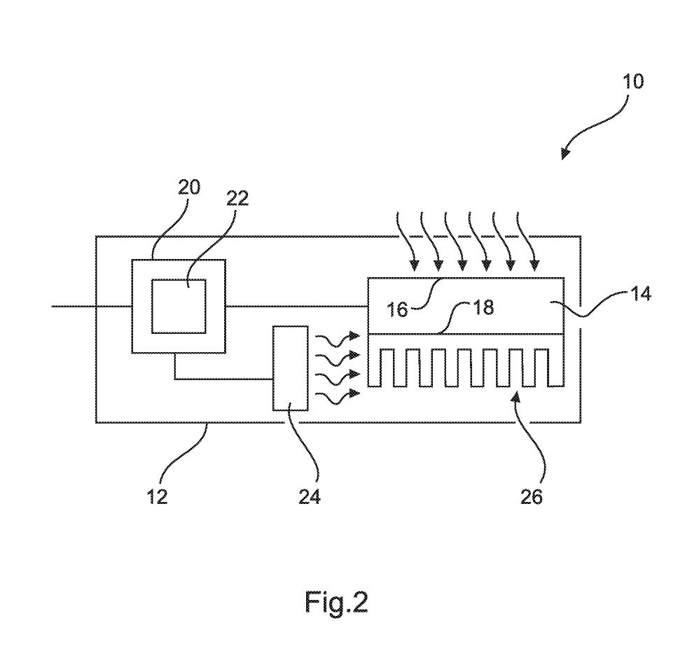

FIG. 2 shows one exemplary embodiment of the holding device according to the invention in a schematic illustration; and

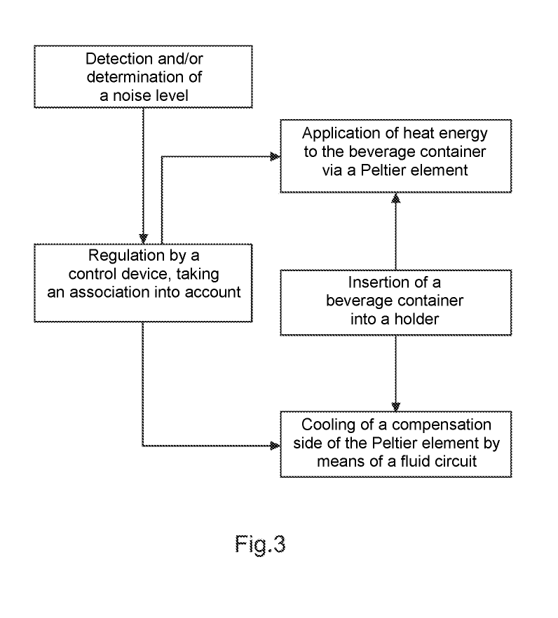

FIG. 3 shows one exemplary embodiment of the method according to the invention for operating a holding device.

FIGS. 1a and 1b show individual aspects that may be provided in a holding device according to the invention or when implementing a method according to the invention for operating a holding device, based on a diagram.

Reference numeral 100 denotes the electrical power of a thermoelectric device as a function of the voltage. Reference numeral 102 denotes a heat pump effect of the thermoelectric device as a function of the voltage, for a first fluid flow rate per unit time of a fluid conveying device that is in heat transfer connection with the compensation side of the thermoelectric device. Reference numeral 104 denotes a heat pump effect of the thermoelectric device as a function of the voltage, for a second fluid flow rate per unit time of the fluid conveying device that is in heat transfer connection with the compensation side of the thermoelectric device. The first fluid flow rate per unit time is greater than the second fluid flow rate per unit time.

In addition, reference numeral 106 denotes the cooling power of the thermoelectric device for the first fluid flow rate per unit time of the fluid conveying device that is in heat transfer connection with the compensation side of the thermoelectric device. Reference numeral 108 denotes the cooling power of the thermoelectric device for the second fluid flow rate per unit time of the fluid conveying device that is in heat transfer connection with the compensation side of the thermoelectric device.

The cooling power 106 results from the difference between the heat pump effect 102 of the thermoelectric device and the electrical power 100 of the thermoelectric device. The cooling power 108 results from the difference between the heat pump effect 104 of the thermoelectric device and the electrical power 100 of the thermoelectric device.

The point 110 shows the cooling power of the thermoelectric device for the first fluid flow rate per unit time and a voltage of 13.5 volts. The point 112 shows the cooling power of the thermoelectric device for the second fluid flow rate per unit time and a voltage of 13.5 volts. The voltage of 13.5 volts corresponds to the voltage of the vehicle electrical system. It is apparent from points 110 and 112 that at a voltage of 13.5 volts, the thermoelectric device does not generate the greatest possible cooling power 106 or 108.

Therefore, information is stored on a regulation device of the holding device, by means of which different setpoint voltages may be associated with different fluid flow rates per unit time. The association or the information is such that the voltage of the thermoelectric device may be set for each fluid flow rate in such a way that the thermoelectric device provides the greatest possible cooling power.

If the fluid flow rate per unit time is specified, the regulation device makes an adaptation of the voltage for the thermoelectric device, taking the information into account. In the present case, a voltage of 10 V is associated with the first fluid flow rate per unit time. Thus, the voltage for the first fluid flow rate per unit time is automatically set to 10 V by the regulation device. The cooling power 106 is then at point 114, and is greater compared to point 110, at which the thermoelectric device is acted on by a voltage of 13.5 volts. Controlling the temperature of an object may thus take place with a reduced energy expenditure and with a greater cooling power 106.

The illustrations in FIGS. 1a and 1b also depict the behavior of the holding device when the quantity of fluid is reduced. The cooling power in this case is denoted by reference numeral 108, as mentioned above. Without adapting a voltage for the thermoelectric device or maintaining the voltage of 10 volts, the cooling power 108 of the thermoelectric device would be according to point 116, and thus would not be fixed in the optimal effective range of the thermoelectric device. For this reason, the voltage is re-adapted by means of the above-described information or the above-described association, and the voltage of 10 volts is reduced to 8 volts. The thermoelectric device is hereby operated in the optimal effective range, denoted by reference numeral 118. The cooling power 108 for the second fluid flow rate per unit time is now as great as possible. The adaptation of the voltage may take place at least approximately in real time when the fluid flow rate per unit time is increased or decreased. The arrow illustrated by position 120 denotes the adaptation of the voltage. The regulation device may have a voltage converter for adapting the voltage. For the sake of completeness, it is also noted that in practice, a voltage may also be initially set, i.e., increased or decreased, and the fluid flow rate per unit time is then automatically adapted, taking into account the association or the information stored on the regulation device, in order to operate the thermoelectric device with the greatest possible power.

FIG. 2 shows a holding device 10 for a vehicle having a temperature control device 12. The temperature control device 12 includes a thermoelectric device 14 which may be operated as a Peltier element and as a Seebeck element.

The thermoelectric device 14 has a use side 16 and a compensation side 18, the use side being in heat transfer connection with a temperature control area, so that the temperature control area may be cooled or heated by the thermoelectric device 14. Thermal conduction ribs 26 which facilitate the heat exchange with the surroundings are situated on the compensation side 18 of the thermoelectric device 14.

The temperature control device 12 includes a regulation device 20 that at least temporarily applies a working voltage to the thermoelectric device 14, the working voltage being an unclocked direct voltage. The temperature control device 12 is provided for operating at a supply voltage, the supply voltage being a direct voltage. In addition, the working voltage has a different magnitude than the supply voltage. The temperature control device 12 also includes a fluid conveying device 24 that is designed as a fan and is configured for discharging, by fluid movement, waste heat that arises at the compensation side 18 of the thermoelectric device 14, or for supplying the compensation side 18 of the thermoelectric device 14 with heat by fluid movement. The fluid movement is achieved by the acceleration of the ambient air.

The regulation device 20 has a voltage converter 22 which is at the supply voltage during operation and which at least temporarily delivers an output voltage, wherein the output voltage of the voltage converter 22 corresponds to the working voltage, and is a direct voltage that is different from the supply voltage. The regulation device 20 is also configured for autonomously setting the working voltage of the thermoelectric device and the fluid flow rate per unit time of the fluid conveying device 24, the working voltage of the thermoelectric device 14 being autonomously settable as a function of the fluid flow rate per unit time of the fluid conveying device 24, or the fluid flow rate per unit time of the fluid conveying device 24 being autonomously settable as a function of the working voltage of the thermoelectric device 14.

The temperature control device 12 may be operated in different operating modes, for example in a sound volume-optimized operating mode, an energy-saving operating mode in which a thermal function at reduced power consumption is provided, an operating mode for producing ice, an operating mode for avoiding ice formation, an operating mode for avoiding condensate formation, and an operating mode in which the net power is optimized.

The holding device 10 may be a glove compartment, a beverage holder, or a cool box. In addition, the holding device 10 is installable in a vehicle and operable in a vehicle.

The block diagram in FIG. 3 depicts one conceivable implementation for the method according to the invention for operating a holding device. Thus, within the scope of one method step, a noise level present in the interior of a motor vehicle is detected. The detection may take place by means of a sensor, for example, that is coupled to a regulation device that is referred to as a control device. In addition, a beverage container is inserted into a beverage holder and selectively acted on by heat energy or cold energy via a Peltier element. Specifying the action of heat energy or cold energy on the beverage container may take place via a user interface that is connected to the control device.

A quantity of a fluid to be moved per unit time is then increased or decreased as a function of a detection of the noise level, which may take place by means of the sensor. The control device has information concerning which quantities of fluid to be moved per unit time to associate with a particular voltage for the Peltier element. When the quantity of fluid to be moved per unit time is increased or decreased by the control device, an adaptation of the voltage provided for the Peltier element may take place preferably in real time, taking the information or the association into account.

### LIST OF REFERENCE NUMERALS

10 holding device
12 temperature control device
14 thermoelectric device
16 use side
18 compensation side
20 regulation device
22 voltage converter of the regulation device
24 fluid conveying device
26 heat transport ribs
100 electrical power
102 heat pump effect
104 heat pump effect
106 cooling power
108 cooling power
110-118 operating points
120 voltage adaptation

1. A holding device for a vehicle, having
at least one temperature control device that includes at least one thermoelectric device,
the at least one thermoelectric device having a use side and a compensation side,
wherein the temperature control device includes at least one regulation device that at least temporarily applies a working voltage to the at least one thermoelectric device, and the working voltage is a direct voltage.

2. The holding device according to claim 1, wherein the working voltage is unclocked.

3. The holding device according to claim 1, wherein a voltage converter which is at a supply voltage during operation.

4. The holding device according to claim 1,
wherein the at least one temperature control device is provided for operating at a supply voltage, the supply voltage is a direct voltage, and/or the working voltage has a different magnitude than the supply voltage.

5. The holding device according to claim 1,
wherein the at least one regulation device has at least one voltage converter, which during operation is at a supply voltage and/or at least temporarily delivers an output voltage.

6. The holding device according to claim 1,
wherein an output voltage of the voltage converter of the at least one regulation device corresponds to the working voltage, and/or is a direct voltage that is different from the supply voltage.

7. The holding device according to claim 1,
wherein the holding device is designed as a glove compartment, beverage holder, or cool box, the holding device being integrated into the vehicle, or installable in a vehicle or operable in a vehicle as a retrofittable accessory.

8. The holding device according to claim 1,
wherien the at least one temperature control device has at least one fluid conveying device that is configured for discharging, by fluid movement, waste heat that arises on the compensation side of the thermoelectric device, and/or for supplying the compensation side of the thermoelectric device with heat by fluid movement.

9. The holding device according to claim 8, wherein the at least one regulation device is configured for autonomously setting the working voltage and/or the fluid flow rate per unit time of the at least one fluid conveying device.

10. (canceled)

11. The holding device according to claim 1,
wherein the at least one temperature control device has one, multiple, or all operating modes including:
a sound volume-optimized operating mode;
an energy-saving operating mode in which a thermal function at reduced power consumption is provided;
an operating mode for producing ice;
an operating mode for avoiding ice formation;
an operating mode for avoiding condensate formation; and
an operating mode in which the net power is optimized.

12. The holding device according to claim 1,
wherein the at least one temperature control device avoids the development of current spikes when at least one operating mode is activated.

13. A holding system having
at least two holding devices that are designed according to claim 1,
wherein a regulation device divides available energy between the at least two holding devices, depending on an operating mode selected.

14. The holding device according to claim 13, wherein the two holding devices are each operable in a heating mode and in a cooling mode; and
wherein at least one operating mode is settable by means of the reputation device, the least one operating mode including:
the at least one operating mode in which one holding device is operated in the heating mode and one holding device is operated in the cooling mode;
the at least one operating mode in which one holding device is deactivated and one holding device is operated in the cooling mode;
the at least one operating mode in which one holding device is deactivated and one holding device is operated in the heating mode;
the at least one operating mode in which the two holding devices are each operated in the heating mode; and
the at least one operating mode in which the two holding devices are each operated in the cooling mode.

15. (canceled)

16. A method for operating a holding device for a vehicle, the method comprising:
providing a temperature control device that includes at least one thermoelectric device, the at least one thermoelectric device having a use side and a compensation side,
wherein the method includes:
at least temporarily applying a working voltage to the at least one thermoelectric device, the working voltage being a direct voltage.

17. The method according to claim 16, wherein the method includes at least one of the following steps:
converting the supply voltage by at least one voltage converter;
setting the working voltage that is at least temporarily applied to the thermoelectric device; and
wherein the method includes at least one of the following steps:
discharging waste heat that arises on the compensation side of the thermoelectric device, by means of a fluid conveying device; and
supplying heat to the compensation side of the thermoelectric device by means of a fluid conveying device.

18. (canceled)

19. The method according to claim 16, wherein the method includes at least one of the following steps:
autonomously setting the working voltage as a function of a fluid flow rate per unit time of the fluid conveying device;
autonomously setting the fluid flow rate per unit time of the fluid conveying device, as a function of the working voltage.

20. The method according to claim 16, wherein the method includes at least one of the following steps:
detecting a noise level by sensor;
autonomously setting the fluid flow rate per unit time of the fluid conveying device as a function of the detected noise level; and
wherein the method includes at least one of the follow steps:
setting a sound volume-optimized operating mode for the temperature control device;
setting an energy-saving operating mode in which a thermal function at reduced power consumption is provided for the temperature control device;
setting an operating mode for producing ice for the temperature control device;
setting an operating mode for avoiding ice formation for the temperature control device; and
setting an operating mode for avoiding condensate formation for the temperature control device.

21. (canceled)

22. A method for operating a holding system having at least two holding devices, which in each case are preferably operated according to claim 16, wherein the method includes the steps of:
dividing the available energy between the at least two holding devices, depending on the operating mode selected.

23. The method according to claim 22, wherein the two holding devices are each operable in a heating mode and in a cooling mode.

24. The method according to claim 22, wherein the method includes at least one of the following steps:
setting an operating mode in which one holding device is operated in the heating mode and one holding device is operated in the cooling mode;
setting an operating mode in which one holding device is deactivated and one holding device is operated in the cooling mode;
setting an operating mode in which one holding device is deactivated and one holding device is operated in the heating mode;
setting an operating mode in which the two holding devices are each operated in the heating mode; and
setting an operating mode in which the two holding devices are each operated in the cooling mode.

25. (canceled)
